(19) United States
(12) Patent Application Publication
(10) Pub. No.: US 2004/0014575 A1
(43) Pub. Date: Jan. 22, 2004

(54) Contest entry blank

(76) Inventor: Keith Paxton, Allen, TX (US)

Correspondence Address: Frederick H. Colen, Reed Smith LLP, P.O. Box 488, Pittsburgh, PA, 15230-0488, US

(21) Appl. No.: 10/199,162

(22) Filed: Jul. 19, 2002

(51) Int. Cl. B31B 1/00

(52) U.S. Cl. 493/51

(57) ABSTRACT

A contest entry blank is provided. The entry blank has three panels. The first panel is connected to the second panel. In turn, the second panel is connected to the third panel. The three panels are arranged such that they may be folded to form a two-sided entry blank. In a preferred embodiment, the contest entry blank is provided integral with a container.

### FIELD OF THE INVENTION

The present invention relates generally to a contest entry blank and a method of conducting a contest. In particular, the present invention relates to a contest entry blank provided integral with a container.

### DISCUSSION OF RELATED ART

In order to promote sales of, or interest in a product or services, many businesses conduct contests whereby consumers who purchase a product may retrieve a contest entry blank. The consumer is required to provide personal information, such as an address, phone number, and possibly email address on the contest entry blank. The consumer then places the proper postage on the entry and mails it to the business. Typically, the entry blanks are collected, and a winner or multiple winners are randomly drawn from all of the entries received by the business.

Contest entry blanks have been provided to consumers in several ways. The entry blanks often come in the form of a bound stack of postcards. The consumer removes one postcard from the stack, enters the required information and mails the entry. However, these stacks of postcards are typically provided separate from any goods or services that may be purchased by the consumer. As a result, a display is often used to attract the attention of the consumer to the contest entry blanks. The displays are costly and may occupy valuable floor space in a place of business.

Contest entry blanks also have been printed on a surface, such as a back panel or inside panel, of food boxes or wrappers. Typically, the contest entry blanks are provided in a fashion that require the consumer to remove the contest entry blank from the box or wrapper, fill out the blank, place it in an envelope, address the envelope and mail the envelope to the business conducting the contest. However, these contest entry blanks suffer from the deficiency of requiring the consumer to address the envelope, which can lead to inaccuracies in the address. Also, recent concerns about the use of envelopes in connection with bio-terrorism make it less desirable for a business to receive hundreds or thousands of envelopes from consumers.

It is therefore desirable to provide a consumer with a contest entry blank, without requiring the consumer to choose to remove the entry blank from a separate display. It is also desirable to provide an entry blank in a manner that does not require the consumer to utilize an envelope in order to submit the entry blank to the business conducting the contest.

### SUMMARY OF THE INVENTION

In accordance with the present invention, a contest entry blank is provided. The contest entry blank is a multi-panel entry blank that may be folded to form a two-sided contest entry blank. The contest entry blank is provided integral with a container.

In an embodiment of the present invention, a contest entry blank is provided. The contest entry blank comprises a first panel, a second panel connected to the first panel, and a third panel connected to the second panel. The first panel, the second panel and the third panel are arranged such that they may be folded and sealed together to form a two-sided entry blank and the first panel, the second panel and the third panel are provided integral with a container.

In another embodiment of the present invention, a contest entry blank is provided. The contest entry blank comprises a first panel, a second panel connected to the first panel, and a third panel connected to the second panel. The first panel, the second panel and the third panel are arranged such that they may be folded and sealed together to form a two-sided entry blank. The first panel, the second panel and the third panel are provided integral with a bag, and have indicia around their perimeter. The first and second panels are substantially rectangular in shape and have dimensions of approximately 3½ by 5 inches, and the contest entry blank has a total thickness of is between approximately 0.007 inches and approximately 0.016 inches.

In further embodiment of the present invention, a method for conducting a contest is provided. The method comprises a providing a contest entry blank. The contest entry blank comprises a first panel, a second panel connected to the first panel, and a third panel connected to the second panel. The first panel, the second panel and the third panel are arranged such that they may be folded and sealed together to form a two-sided entry blank. The method further comprises providing an address to which a contestant must mail the contest entry blank, collecting all the contest entry blanks received at the address and selecting at least one winner from the collected contest entry blanks.

### BRIEF DESCRIPTION OF THE DRAWINGS

The various features and benefits of the present invention are apparent in light of the following detailed description and the accompanying drawings, in which:

FIG. 1 is a side elevational view of an un-assembled contest entry blank in accordance with an embodiment of the present invention.

FIG. 2 is a perspective view of an un-assembled contest entry blank provided integrally with a bag, in accordance with an embodiment of the present invention.

FIG. 3a is a side elevational view of a partially assembled contest entry blank in accordance with an embodiment of the present invention.

FIG. 3b is a side elevational view of a partially assembled contest entry blank in accordance with an embodiment of the present invention.

FIG. 3c is a front elevational view of a fully assembled contest entry blank in accordance with an embodiment of the present invention.

FIG. 3d is a rear elevational view of the fully assembled contest entry blank illustrated in FIG. 3c, in accordance with an embodiment of the present invention.

### DETAILED DESCRIPTION OF THE INVENTION

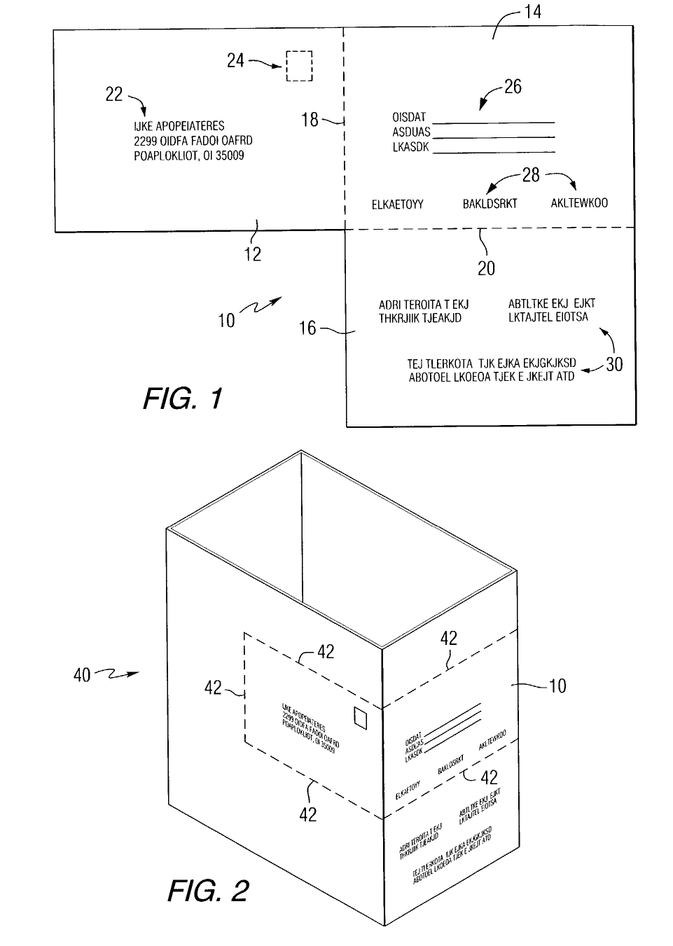

FIG. 1 illustrates an example contest entry blank 10 in accordance with the present invention. Reference to the contest entry blank 10 herein will be a reference to the contest entry blank in its un-assembled or partially assembled form. The contest entry blank 10 comprises a first panel 12, a second panel 14 and a third panel 16. In the embodiment illustrated, the first panel 12 and the second panel 14 are connected to each other along a first side 18. The third panel 16 is connected to the second panel 14 along a second side 20. In the embodiment shown, the first side 18 and the second side 20 are adjacent to each other. Alternatively, the first side 18 and the second side 20 may be opposite one another.

The first panel 12 has indicia 22 printed on one side. In the embodiment shown, the indicia 22 designate an address to which the contest entry blank 10 must be mailed in order to be considered a valid entry by the business conducting the contest. The pre-printed address on the entry blank 10 eliminates the need for a consumer to write the address on the contest entry blank 10 prior to mailing, which in turn, eliminates the possibility of an incorrect address being written on the contest entry blank 10. The first panel 12 also has indicia 24 that designates the proper location for postage, and may indicate the amount of postage required, as well as a reminder to place the proper postage on the entry blank 10 prior to mailing.

The second panel 14 also has indicia 26 printed on one side. In the embodiment shown, the indicia 26 prompt a consumer to provide personal information required to enter a contest, for example, address information, phone number and age of the contest entrant. The indicia 26 may also prompt the consumer for other information, for example, an email address. The second panel 14 may also have other indicia, such as indicia 28. In the example embodiment shown, the indicia 28 represents advertising materials, as well as contest rules.

The third panel 16 may also have indicia 30 printed on one side. In the embodiment shown, the indicia 30 provide instructions for assembling the contest entry 10. The indicia 30 may indicate anything the business conducting the contest desires, or alternatively, may be omitted.

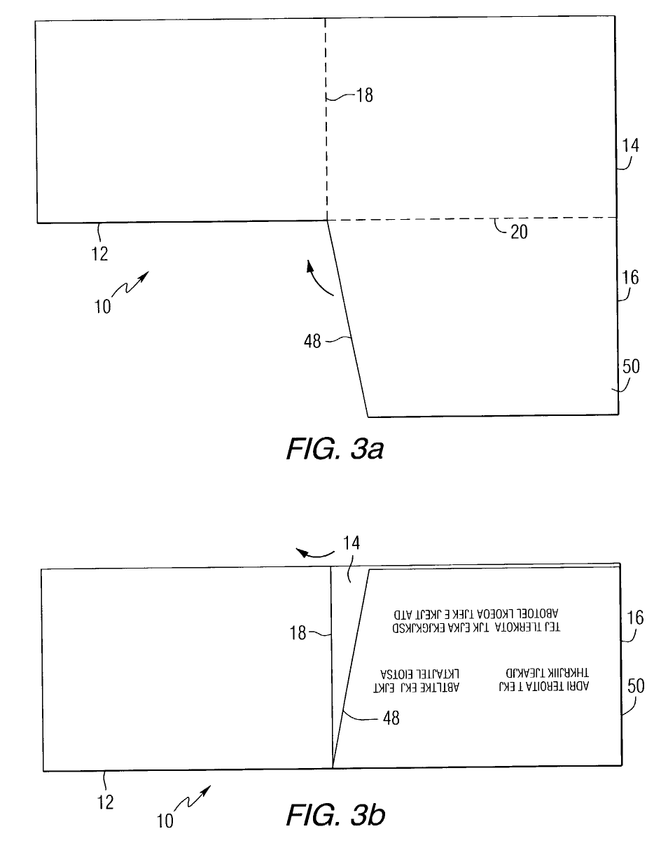

FIG. 2 illustrates an example contest entry blank 10 provided integral with a container. As used herein, and throughout the claims, the phrase “provided integral with a container” means that the contest entry blank 10 is provided as part of, or formed with, or attached to, or releasably attached to, or fastened to a container. Examples of suitable containers include a bag, a box, a can, a wrapper, a canister, a jug and a bottle. Any suitable container known in the art may be used. In the example embodiment shown, the contest entry blank 10 is provided integral with a bag 40. The bag 40 may be any appropriate paper bag, for example a shopping bag, or a fast-food bag. The indicia 22, 24, 26 and 28 may be printed either on the inside or the outside of the bag 40, or both. In the example embodiment shown the various indicia 22, 24, 26 and 28 are printed on the outside of the bag 40. In this way, a consumer may observe the various indicia 22, 24, 26 and 28 without looking inside the bag 40. Preferably, the bag 40 is a bag made from standard paper stock.

In the example embodiment illustrated in FIG. 2, the contest entry blank 10 also includes indicia 42 around the perimeter of un-assembled contest entry blank 10. In the example shown, the indicia 42 indicate where a consumer should cut in order to separate the contest entry blank 10 from the bag 40. The indicia 42 may also indicate the location of a preferential area of weakness formed in the bag 40. Any appropriate means known in the art for providing a preferential area of weakness may be utilized. The preferential area of weakness may be formed, for example, by scoring the bag 40 in the desired location. The preferential area of weakness around the perimeter of un-assembled entry blank 10 allows a consumer to remove the contest entry blank 10 from the bag 40 without the use of a cutting device, such as a knife or a pair of scissors.

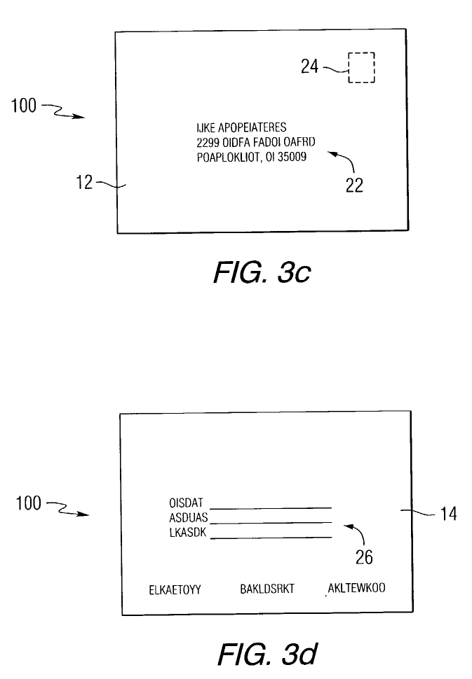

FIGS. 3a-3d illustrate a method of assembling the contest entry blank 10 in accordance with an embodiment of the present invention. FIG. 3a shows the contest entry blank 10 after it has been removed from the bag 40 shown in FIG. 2. The sides of the three panels 12, 14, 16 shown in FIG. 3a are opposite those that contain the indicia 22, 26, 28 and 30 shown in FIG. 1. That is, the sides of the three panels 12, 14, 16 shown in FIG. 3a are the sides that will be “inside” the contest entry blank 10 when it is fully assembled.

After the contest entry blank 10 has been removed from the bag 40, the third panel 16 is folded along the side 20, towards the second panel 14, as illustrated in FIG. 3b. The third panel 16 may optionally be adhered to the second panel 14. The third panel 16 may be adhered to the second panel 14 by any appropriate means, for example, by adhesive provided either on the second panel 14 or on the third panel 16, or by tape. Preferably, in order to reduce costs, the third panel 16 is not adhered directly to the second panel 14.

Next, the second panel 14 and the third panel 16 are both folded towards the first panel 12 along the side 18 to form the two-sided contest entry blank 100 shown in FIGS. 3c-3d. Reference to the contest entry blank 100 herein will be a reference to the contest entry blank in its assembled form. The contest entry blank 100, once assembled, has the first panel 12 with the indicia 22 facing outward. Likewise, the contest entry blank 100 also has the second panel 14 with indicia 26, 28 also facing outward, on the side of the contest entry blank 100 opposite that of the indicia 22.

In order to keep the contest entry blank 100 assembled, the second panel 14 and the third panel 16 are preferably adhered to the first panel 12. If the third panel 16 has previously been adhered to the second panel 14, then the consumer may adhere the first panel 12 to either the third panel 16 or to the second panel 14. Preferably, the third panel 16 is not directly attached to the second panel 14, but instead is held in place between the first panel 12 and the second panel 14, which are adhered together. The first panel 12 and the second panel 14 may be adhered together by any suitable means known in the art, for example, by tape provided by the consumer.

The contest entry blank 100 may have any dimensions and weight, as long as it may be mailed by a consumer to the business conducting the contest. To make mailing the contest entry blank 100 convenient for a consumer, the contest entry blank is preferably sized to meet United States Postal Service Regulations for Standard Business Reply Mail (United States Postal Service “Designing Letter and Reply Mail,” Publication 25, Mar. 2001) (“USPS Regulations”). In this way, a consumer must only attach first class postage in order to have the contest entry blank 100 delivered to the designated address.

When the contest entry blank 100 is fully assembled, as shown in FIGS. 3c-3d, the first and second panels 12, 14 constitute the two sides of the contest entry blank 100. Therefore, the fully assembled contest entry blank 100 will have the same dimensions as the first and second panels 12, 14. As discussed above, the first and second panels 12, 14 (and therefore, contest entry blank 100) may have any dimensions, as long as contest entry blank 100 may be mailed by a consumer to the business conducting the contest. Preferably, the first panel 12 and the second panel 14 are rectangular in shape, and have dimensions of approximately 3½ inches by approximately 5 inches.

The third panel 16 is sized to be smaller than the first panel 12 and the second panel 14. In this way, the third panel 16 may easily fit between the first panel 12 and the second panel 14 when the contest entry blank 100 is fully assembled. The third panel 16 has a side 48 that is in close proximity to the side 18 when the third panel 16 is folded against the second panel 14, as illustrated in FIG. 3b. To facilitate folding, the side 48 may be tapered, that is angled towards the opposite side 50 of the third panel 16 instead of being parallel with the opposite side 50.

It is also preferable to also construct the contest entry blank 100 such that it meets the thickness requirements for Business Reply Mail set forth in the USPS Regulations. In this way, a consumer need only attach first class postage to the contest entry blank 100 and mail it in order to have it delivered to the business conducting the contest. The USPS Regulations provide that Business Reply Mail should have a thickness of between 0.007 and 0.016 inches for a 3½ by 5 inch card. Therefore, if the preferred dimensions of 3½ by 5 inches are used for the contest entry blank 100, the total thickness of the contest entry blank 100 preferably will be between 0.007 and 0.016 inches.

In a preferred embodiment, the contest entry blank 100 is provided integral with a restaurant take-out bag 40, as shown in FIG. 2. In this embodiment, the take-out bag 40 is a #10 size bag made from standard paper stock. The walls of bag 40, and therefore, the first, second and third panels 12, 14, 16 each have a thickness of approximately 0.00325 inches. When the contest entry blank 100 is assembled, as shown in FIGS. 3c-3d, it has a thickness equal to the sum of the thicknesses of the first, second and third panels 12, 14, 16. Therefore, in this preferred embodiment, the contest entry blank 100 has a thickness of approximately 0.00975 inches, thus meeting the USPS Regulations for Business Reply Mail.

In another embodiment of the present invention, a method of conducting a contest is provided. The method comprises providing a contest entry blank 10 as described above. Preferably, the contest entry blank 10 is provided integral with a bag 40, as described above. The method further comprises providing an address to which a contestant must mail the contest entry blank. This is preferably done by way of indicia pre-printed on the contest entry blank 10, as described above. The business then collects all the contest entry blanks 100 that are received at the address. At least one winner is selected from all the contest entry blanks 100 that are received and collected at the address.

The business may also indicate on the contest entry blank 10 through the use of indicia, as described above, that the contest entry blank 100 must meet certain criteria before it will be considered a valid entry. For example, the consumer may be required to be of a certain age before he or she may enter the contest. Also, it may be required that certain information must be provided by the consumer, such as a telephone number or a valid email address. In such cases, the method of conducting the contest may further include examining the contest entry blanks 100 that are received and collected and determining if any of the contest entry blanks 100 do not meet the eligibility requirements listed on the contest entry blank 100. Any contest entry blanks 100 that do not meet those requirements may be eliminated from the contest.

While specific embodiments and methods for practicing this invention have been described in detail, those skilled in the art will recognize various manifestations and details that could be developed in light of the overall teachings herein. Accordingly, the particular embodiments disclosed are meant to be illustrative only and not to limit the scope of the invention which is to be given the full breadth of the following claims and any and all embodiments thereof.

What is claimed is:

1. A contest entry blank comprising a first panel, a second panel connected to the first panel, and a third panel connected to the second panel, wherein the first panel, the second panel and the third panel are arranged such that they may be folded and sealed together to form a two-sided entry blank, and the first panel, the second panel and the third panel being provided integral with a container.

2. The contest entry blank of claim 1, wherein the container is selected from the group consisting of a bag, a box, a can, a wrapper, a canister, a jug and a bottle.

3. The contest entry blank of claim 1, wherein the first panel, the second panel and the third panel have indicia around their perimeter.

4. The contest entry blank of claim 1, wherein a preferential area of weakness is formed along the perimeter of the three panels.

5. The contest entry blank of claim 4, wherein the preferential area of weakness is formed by scoring the container.

6. The contest entry blank of claim 1, wherein the first panel has indicia on one side indicating a space for a contest entrant to enter personal information.

7. The contest entry blank of claim 1, wherein the second panel has indicia on one side indicating an address to which a contest entrant can mail the entry blank.

8. The contest entry blank of claim 1, wherein the third panel has indicia on one side indicating directions for folding and sealing the contest entry blank.

9. The contest entry blank of claim 1, wherein the first panel is substantially rectangular in shape and the second panel is rectangular in shape.

10. The contest entry blank of claim 1, wherein the first panel is connected to the second panel along a side, and the third panel is connected to the second panel along a side of the second panel that is adjacent the side of the second panel to which the first panel is connected.

11. The contest entry blank of claim 9, wherein the first and second panels have dimensions of approximately 3½ by 5 inches.

12. The contest entry blank of claim 1, wherein the first panel, the second panel and the third panel each are approximately 0.00325 inches thick.

13. The contest entry blank of claim 1, wherein the total thickness of the contest entry blank, when assembled, is between approximately 0.007 inches and approximately 0.016 inches.

14. The contest entry blank of claim 13, wherein the total thickness of the contest entry blank is approximately 0.00975 inches.

15. A contest entry blank comprising a first panel, a second panel connected to the first panel, and a third panel connected to the second panel, wherein the first panel, the second panel and the third panel are arranged such that they may be folded and sealed together to form a two-sided entry blank, the first panel, the second panel and the third panel being provided integral with a bag, the first panel, the second panel and the third panel have indicia around their perimeter, the first and second panels are substantially rectangular in shape and have dimensions of approximately 3½ by 5 inches, and the contest entry blank, when assembled, has a total thickness of between approximately 0.007 inches and approximately 0.016 inches.

16. A contest entry blank comprising a first panel, a second panel connected to the first panel, and a third panel connected to the second panel, wherein the first panel, the second panel and the third panel are arranged such that they may be folded and sealed together to form a two-sided entry blank, and the first panel, the second panel and the third panel being provided integral with a container.

17. A method of conducting a contest comprising:
a) providing a contest entry blank, the contest entry blank comprising a first panel; a second panel connected to the first panel; and a third panel connected to the second panel; wherein the first panel, the second panel and the third panel are arranged such that they may be folded and sealed together to form a two-sided entry blank;
b) providing an address to which a contestant must mail the contest entry blank;
c) collecting all contest entry blanks received at the address; and
d) selecting at least one winner from the collected contest entry blanks.

18. The method of claim 17 wherein the first panel, the second panel and the third panel are provided integrally with a container.

19. The contest entry blank of claim 18, wherein the container is selected from the group consisting of a bag, a box, a can, a wrapper, a canister, a jug and a bottle.

20. The method of claim 18, wherein the first panel, the second panel and the third panel contain indicia around their perimeter.

21. The method of claim 18, wherein a preferential area of weakness is formed along the perimeter of the three panels.

22. The method of claim 21, wherein the preferential area of weakness is formed by scoring the container.

23. The method of claim 17, wherein the first panel has indicia on one side indicating a space for a contest entrant to enter personal information.

24. The method of claim 17, wherein the address is provided as indicia on one side of the second panel of the contest entry blank.

25. The method of claim 17, wherein the third panel has indicia on one side indicating directions for folding and sealing the contest entry blank.

26. The method of claim 17, wherein the first panel is rectangular in shape and the second panel is rectangular in shape.

27. The method of claim 26, wherein the first and second panels have dimensions of approximately 3½ by 5 inches.

28. The method of claim 17, wherein the first panel is connected to the second panel along a side, and the third panel is connected to the second panel along a side of the second panel that is adjacent the side of the second panel to which the first panel is connected.

29. The method of claim 17, wherein the first panel, the second panel and the third panel each are approximately 0.00325 inches thick.

30. The method of claim 17, wherein the total thickness of the contest entry blank, when assembled, is between approximately 0.007 inches and approximately 0.016 inches.

31. The method of claim 30, wherein the total thickness of the contest entry blank is approximately 0.00975 inches.

32. The method of claim 17, wherein one of the three panels has indicia that provide eligibility requirements for the contest.

33. The method of claim 32, further comprising determining if any of the received contest entry blanks fails to meet the eligibility requirements for the contest and eliminating any contest entry blanks that fail to meet the eligibility requirements for the contest.
